(19) United States
(12) Patent Application Publication
(10) Pub. No.: US 2011/0028217 A1
(43) Pub. Date: Feb. 3, 2011

(54) TV game dumbbell for fitness exercises

(75) Inventor: Kwok Kee CHONG, Hong Kong (HK)

Correspondence Address: CHIANG, Elsa, Rm404, 4/F., General Commercial Building,, 162 Des Voeux Road, Central, Hong Kong, omitted

(73) Assignee: Qualtech Global Ltd, Hong Kong (HK)

(21) Appl. No.: 12/511,084

(22) Filed: Jul. 29, 2009

(51) Int. Cl. A63F 13/00; A63B 21/072

(52) U.S. Cl. 463/37; 482/108

(57) ABSTRACT

The present utility model puts forward a TV game dumbbell for fitness exercises, comprising: dumbbell bodies and Wii Remote, wherein the Wii Remote is embedded inside the dumbbell bodies. While playing TV games, you can exercise your chest, upper arms and other body parts at the same time, bringing the virtual cyber world to your real life and utilizing the authentic object to show the virtual world, thus realizing a plurality of purposes; moreover, the combination of game and fitness exercises increases the practicability of the controller.

### FIELD OF THE TECHNOLOGY

The present utility model relates to the technical field of a TV game, and more especially, to a TV game dumbbell for fitness exercises by setting TV game device in dumbbell.

### BACKGROUND OF THE TECHNOLOGY

The existing dumbbell and TV game device, and more especially Wii Remote, are mutually independent devices. They have nothing to do with each other and no functions or advantages of them are combined.

### SUMMARY OF THE UTILITY MODEL

The present utility model aims at providing a TV game dumbbell for fitness exercises by overcoming the defects existent in the existing technology so as to improve the practicability of game and people's interest in exercises as well.

The technical solution for the present utility model is as below:

A TV game dumbbell for fitness exercises, comprising: dumbbell and Wii Remote, the Wii Remote is embedded inside the dumbbell.

Wherein: the Wii Remote is embedded inside the dumbbell, specifically comprising: the handles of the dumbbell are provided with a cavity fit for the Wii Remote, a snap-in cover for covering the Wii Remote inside the cavity is connected on the cavity.

Wherein: the Wii Remote includes a controller and a control stick device which are configured on the two dumbbells respectively and connected through a connecting wire, a tunnel is set on one end of each dumbbell body for the connecting wire across it.

Wherein: a hole for revealing the control stick is set in the cover corresponding to the control stick position of the control stick device.

Wherein: the infrared transmitting terminal of the controller aims at the other end of the dumbbell.

Wherein: one end of the dumbbell is provided with an inner cavity in which a counting meter is configured.

Wherein: the inner cavity is covered by a transparent cover.

Wherein: the counting meter can be removed from the dumbbell and used independently.

The beneficial effects realized by the present utility model include: by adopting the TV game dumbbell for fitness exercises in the present utility model, combining TV fitness game with dumbbell exercises, thus improving the practicability of game and people's interest in exercises as well.

### DESCRIPTION OF THE DRAWINGS

FIG. 1 is the schematic view of the structure of the Wii Remote provided by embodiment of the present utility model;

FIG. 2 is the schematic view of the Breakdown Structure of the TV game dumbbell for fitness exercises provided by the embodiment of the present utility model;

FIG. 3 is the schematic view of the structure of the TV game dumbbell for fitness exercises provided by the embodiment of the present utility model (after assembly);

FIG. 4 is the schematic view of the structure of the dumbbell body provided by embodiment of the present utility model;

### DETAILED DESCRIPTION OF THE EMBODIMENTS

The present utility model provides a TV game dumbbell for fitness exercises which can improve the practicability of game and people's interest in exercises as well. To illustrate the purposes, technical solution and advantages of the present utility model clearer, the present utility model is further detailed hereinafter in combination with the drawings and embodiments.

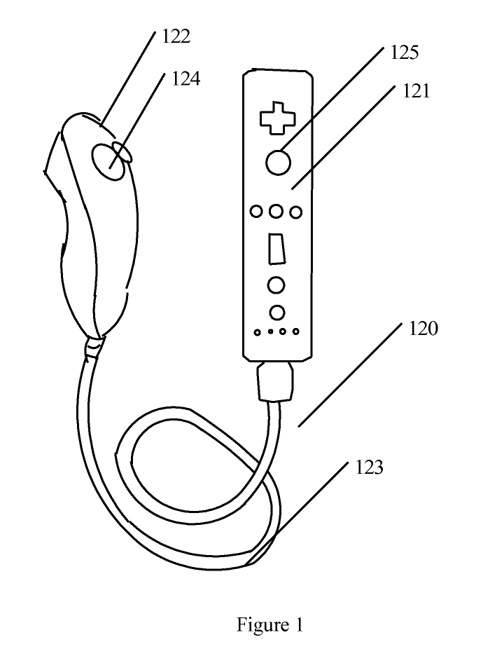

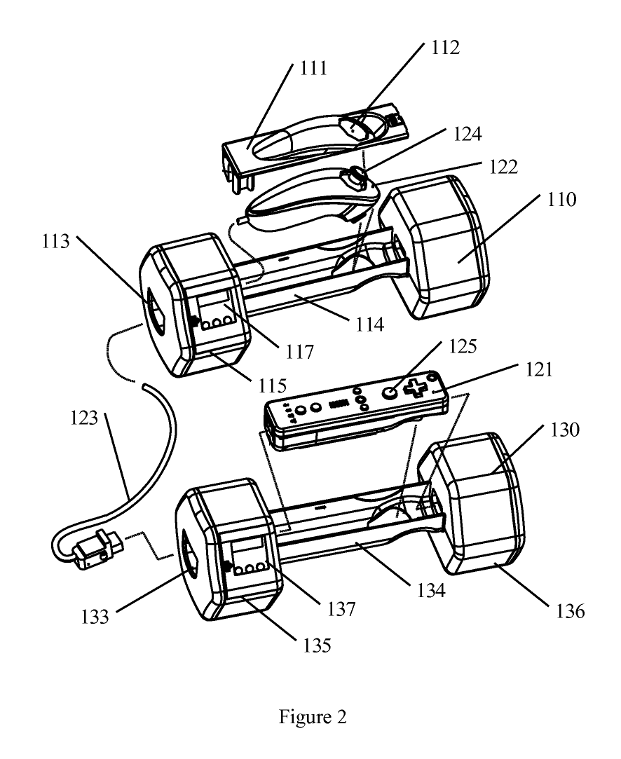

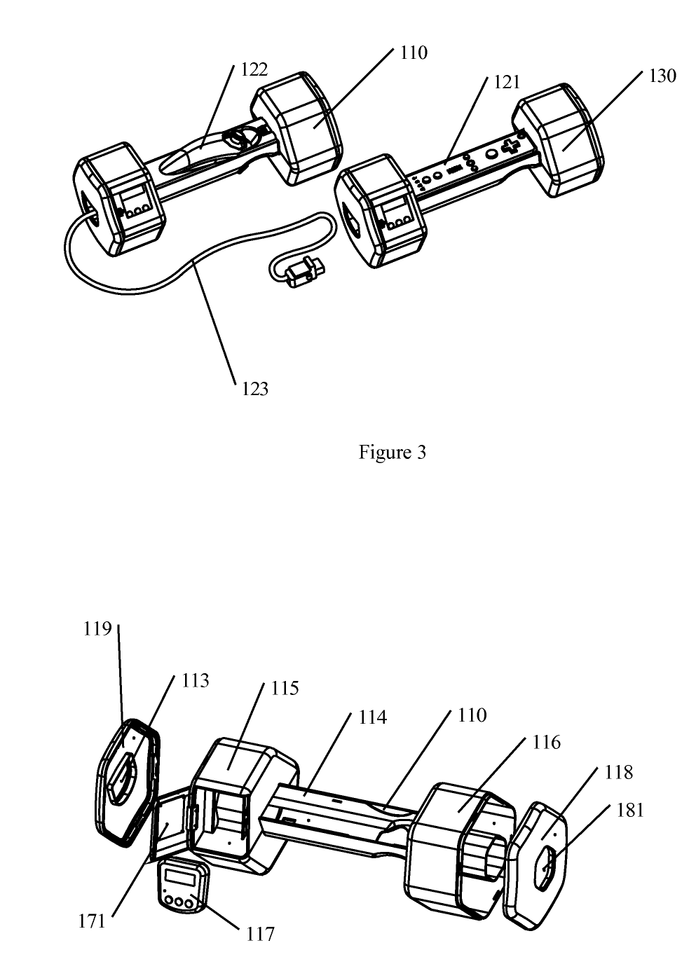

As shown in FIG. 1, a TV game dumbbell for fitness exercises, comprising: dumbbell and Wii Remote 120, the Wii Remote 120 is embedded inside the dumbbell, more specifically, the handles 114, 134 of the dumbbell are provided with a cavity fit for the Wii Remote 120, a snap-on cover for covering the Wii Remote 120 inside the cavity is connected on the cavity, or the Wii Remote 120 is connected on the dumbbell in other ways.

In the further embodiment, the Wii Remote 120 is further connected with a connecting wire 123 which (connecting wire 123) is a data transmitting wire, the Wii Remote 120 includes a controller 121 and a control stick device 122 which (121 and 122) are configured on the two dumbbells 130, 110 respectively and connected through a connecting wire 123, tunnels 113, 133 are set on one end of the dumbbells 110, 130, wherein the connecting wire 123 passes through the tunnels 113, 133.

Wherein, in the further embodiment, to enable the operation to become easier, a hole 112 for revealing the control stick 124 is set in the cover 111 corresponding to the control stick 124 position of the control stick device 122, for easily operating the control stick 124 of the control stick device 122.

In the further embodiment, the infrared transmitting terminal of the controller 121 aims at the other end 136 of the dumbbell body 130.

In the further embodiment, the ends 115, 135 of the dumbbells 110, 130 are provided with an inner cavity in which a counting meter 117 is configured, wherein this meter 117 is used to count the movement of the body.

In the further embodiment, to protect the counting meter 117, the inner cavity is covered by a transparent cover 171.

In the further embodiment, the times counting meter 117 can be removed from the dumbbell body and used independently.

As to the dumbbell, the dumbbell 110 as shown in FIG. 4, comprises both ends 115, 116 and handle 114, the end faces of the both ends 115, 116 are covered by front covers 119, 118 respectively, a tunnel is set in the dumbbell 110, holes 113, 181 are configured in front covers 119, 118 corresponding to the tunnel, one end 115 is provided with a cavity in which a counting meter 117 is set, wherein the meter 117 is covered by a transparent cover 171.

The TV game dumbbell for fitness exercises provided by the abovementioned embodiment combines the functions of a TV game and dumbbell fitness exercises. The dumbbell contains a weight inside, so the application of dumbbell in fitness exercises is unique, safe and convenient. With the proper load, while playing TV game for fun, the energy of the muscle for the upper arms is consumed due to the load, realizing the purpose of exercise. The additional counting meter 117 can record the movement of the arms for formulating a personal exercise plan. The meter 117 can be also used separately in running, jogging, walking and other exercises. While playing TV games, one can exercise your chest, upper arms at the same time, bringing the virtual cyber world to your real life and utilizing the authentic object to show the virtual world, thus realizing a plurality of purposes.

It shall be noted that, the above mentioned embodiment is only applied to illustrate, but not limit, the technical solution of the present utility model. Although the present utility model is detailed by referring to the preferred embodiment, those skilled in the art shall understand that the revisions or equivalent replacements to the technical solution without deviating from the spirit or scope of the technical solution of the present utility model shall be within the scope defined by the claims for the present utility model.

1. A TV game dumbbell for fitness exercises, characterized in that it comprises dumbbell bodies and Wii Remote, wherein the Wii Remote is embedded inside the dumbbell bodies.

2. The TV game dumbbell for fitness exercises according to claim 1, characterized in that the Wii Remote is embedded inside the dumbbell bodies, specifically comprising: the handles of the dumbbell bodies are provided with a cavity fit for the Wii Remote, a snap-on cover for covering the Wii Remote inside the cavity is connected on the cavity.

3. The TV game dumbbell for fitness exercises according to claim 2, characterized in that the Wii Remote includes a controller and a rocker device which are configured on the two dumbbell bodies respectively, and connected through a connecting wire, a tunnel is set on one end of each dumbbell body for the connecting wire across it.

4. The TV game dumbbell for fitness exercises according to claim 3, characterized in that a hole for revealing the rocker is set in the cover corresponding to the rocker position of the rocker device.

5. The TV game dumbbell for fitness exercises according to claim 4, characterized in that the infrared transmitting terminal of the controller aims at the other end of the dumbbell body.

6. The TV game dumbbell for fitness exercises according to claim 3, characterized in that one end of the dumbbell bodies is provided with an inner cavity in which a counting meter is configured.

7. The TV game dumbbell for fitness exercises according to claim 6, characterized in that the inner cavity is covered by a transparent cover.

8. The TV game dumbbell for fitness exercises according to claim 6, characterized in that the times counting meter can be removed from the dumbbell body and used independently.
